(19) United States
(12) Patent Application Publication
(10) Pub. No.: US 2017/0032577 A1
(43) Pub. Date: Feb. 2, 2017

(54) REAL-TIME VIRTUAL REFLECTION

(71) Applicant: FACECAKE MARKETING TECHNOLOGIES, INC., Calabasas, CA (US)

(72) Inventors: Linda Smith, Woodland Hills, CA (US); Clayton Graff, Woodland Hills, CA (US); Darren Lu, Newport Beach, CA (US)

(73) Assignee: FACECAKE MARKETING TECHNOLOGIES, INC., CALABASAS, CA (US)

(21) Appl. No.: 15/293,186

(22) Filed: Oct. 13, 2016

Related U.S. Application Data
(63) Continuation of application No. 13/407,749, filed on Feb. 28, 2012, now abandoned.
Application No. 13/407,749 is a continuation-in-part of application No. 12/033,885, filed on Feb. 19, 2008.
Application No. 12/033,885 is a continuation-in-part of application No. 09/645,292, filed on Aug. 24, 2000, now Pat. No. 7,337,127.
Application No. 13/407,749 is a continuation-in-part of application No. 12/714,518, filed on Feb. 28, 2010, now Pat. No. 9,064,344.
(60) Provisional application No. 61/447,698, filed on Feb. 28, 2011.
(60) Provisional application No. 61/470,481, filed on Mar. 31, 2011.

(51) Int. Cl. G06T 19/00; G06K 9/46; G06F 3/01; G06T 19/20; G06F 3/00; G06K 9/00

(52) U.S. Cl. CPC G06T 19/006; G06F 3/005; G06K 9/00369; G06F 3/017; G06T 19/20; G06K 9/4604; G06T 2219/2016; G06T 2210/16

(57) ABSTRACT

Techniques are provided for a real-time virtual reflection and for video interaction with virtual objects in a system. According to one embodiment, a user's image is captured by a video camera, and is outputted to a visual display in reverse, providing a mirror-image feedback to the user's movements. Through the camera interface, the system interprets user's gestures to manipulate virtual objects in real-time, in conjunction with the user's movements. In some embodiments, a user simulates trying on apparel and accessories according to the techniques set forth.

### CROSS-REFERENCE TO RELATED APPLICATION

This application claims the benefit of provisional Application No. 61/447,698, filed Feb. 28, 2011, and provisional Application No. 61/470,481, filed Mar. 31, 2011. This application is a continuation-in-part of application Ser. No. 12/033,885, filed Feb. 19, 2008, which is a continuation-in-part of application Ser. No. 09/645,292, filed Aug. 24, 2000, now U.S. Pat. No. 7,337,127, the entireties of which are hereby incorporated by reference into this application as if fully set forth herein. This application is a continuation-in-part of application Ser. No. 12/714,518, filed Feb. 28, 2010, the entirety of which is hereby incorporated by reference into this application as if fully set forth herein.

### FIELD OF THE INVENTION

The present invention generally relates to manipulation of captured visual data.

### BACKGROUND OF THE INVENTION

Try-On systems typically allow users to simulate being in a certain environment or having a certain appearance by taking a photograph of a part of the user, and merging the image with other images to generate a new image with the simulation. According to one approach, a photograph of a face of a user is received as input into the system, and the user's face is merged with other images to generate an image that simulates the user's likeness being in another environment, wearing different apparel, or having different features. For example, the user may specify the system to generate an image of the user wearing a hat, having different hair color, and wearing particular clothing, using a photograph of a user that is received as input.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present embodiments of the invention are illustrated by way of example, and not by way of limitation, in the figures of the accompanying drawings and in which like reference numerals refer to similar elements and in which:

FIG. 1 is a diagram that illustrates a user interacting with the system to generate a real-time virtual reflection of the user virtually wearing a purse, according to one embodiment of the invention.

FIG. 2 is a diagram that shows an example of a user's interaction with the real-time virtual reflection system according to one embodiment of the invention.

FIG. 3 is a flow diagram illustrating a computer-implemented process for video interaction with virtual objects according to one embodiment of the invention.

FIG. 4 is a diagram showing an example of an output frame overlaid with icons, with user interaction according to one embodiment of the invention.

FIG. 5 is a flow diagram illustrating a process for applying a virtual object to an output stream of frames based on a concurrently captured stream of frames, wherein a visual data capture device captures video frames and depth cloud data, according to one embodiment of the invention.

FIG. 6 is a diagram showing an image of a virtual object in three rotations, according to one embodiment of the invention.

FIG. 7 illustrates the system performing a side-by-side comparison between one virtual object applied to one output stream, and another virtual object applied to another output stream, according to some embodiments of the invention.

FIG. 8 is a flow diagram illustrating a process for applying a virtual object to an output stream of frames based on a concurrently captured stream of frames without using depth cloud data, according to one embodiment of the invention.

FIG. 9 is a flow diagram for executing a function based on a gesture according to one embodiment of the invention.

FIG. 10 illustrates the system changing user features in the stream of frames according to one embodiment of the invention

FIG. 11 is a diagram illustrating a virtual closet according to one embodiment of the invention.

FIG. 12 is a diagram illustrating one example of a computer system on which some embodiments of the invention are implemented.

### DETAILED DESCRIPTION

In the following description, for the purposes of explanation, numerous specific details are set forth in order to provide a thorough understanding of the present embodiments of the invention. It will be apparent, however, that the present embodiments of the invention may be practiced without these specific details. In other instances, well-known structures and devices are shown in block diagram form in order to avoid unnecessarily obscuring the present embodiments of the invention.

Techniques are provided to create a real-time virtual reflection of a user that shows the user interacting with virtual objects.

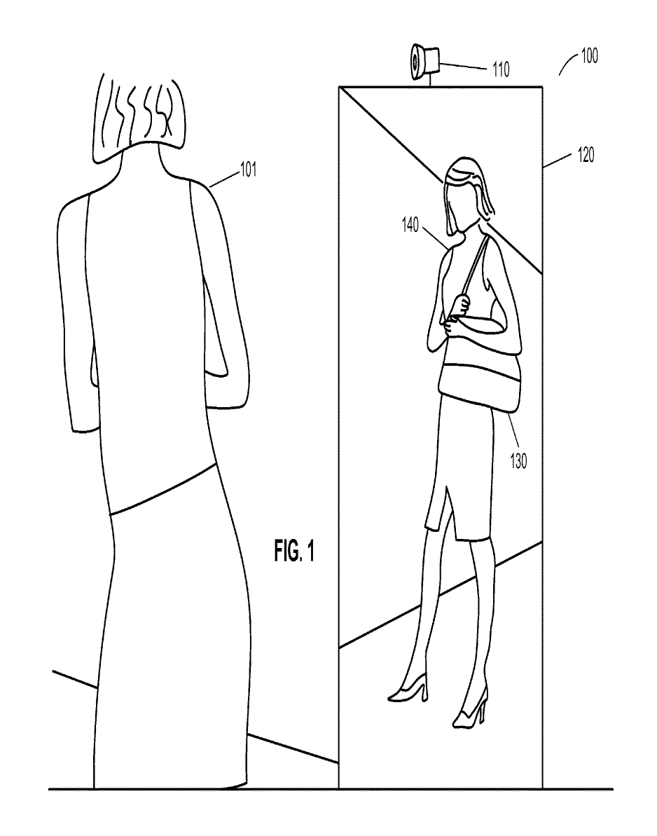

FIG. 1 shows one embodiment of the real-time virtual reflection system 100 in which a user 101 stands in front of visual data capture device 110 and visual display 120. According to the embodiment, the visual data capture device 110 continually captures sequential images of the user, and sends the data to a computer system for processing as a real-time video image that is displayed on visual display 120. The computer processing system receives selection input from user 101 that indicates which virtual object to display with the user's video image. In this embodiment, user 101 has selected a virtual purse 130 to wear in the virtual reflection 140 of user 101.

As shown in FIG. 1, user 101 is moving her body in space as if holding purse in her right arm. The visual data capture device 110 captures user 101's movements in real time, and a computer processing system couples the captured data with a video representation 130 of a purse. In this embodiment, the virtual purse 130 is persistently coupled to the virtual reflection 140 such that the virtual display 120 shows the virtual purse 130 moving with the user 101's movements in real time. Thus, the virtual reflection 140 appears as if it is a reflection of the purse is being worn by the user in real-time.

The visual data capture device 110, according to one embodiment of the invention, includes a depth camera system that is able to capture depth data from a scene. In other embodiments, the visual data capture device 110 includes a 3-D camera that includes two or more physically separated lenses that captures the scene at different angles in order to obtain stereo visual data that may be used to generate depth information. In one embodiment of the invention, a visual data capture device and computer processing system such as the ones described in U.S. patent application Ser. Nos. 11/899,542, and 12/522,171, are used to capture and process the necessary visual data to render virtual reflection 140 on visual display 120. In other embodiments, visual data capture device 110 may include a camera that includes only one aperture coupled with at least one lens for capturing visual data.

In this embodiment, visual display 120 may be part of an audiovisual device, such as a television, a monitor, a high-definition television, a screen onto which an image is projected from a video projector, or any such device that may provide visual data to a user.

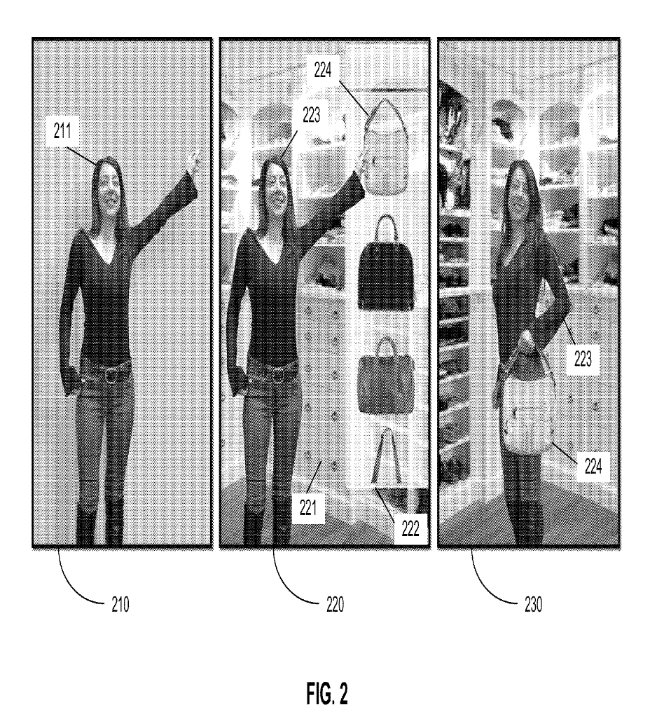

FIG. 2 shows an example of a user's interaction with the real-time virtual reflection system 100 according to one embodiment of the invention. This figure shows one example of a user's interaction with real-time virtual reflection system 100 as a series of three still captures of the video images shown in visual display 120 from three moments in time. At moment 210, the visual data capture device 110 captures the scene of a user posing with one arm extended, and displays virtual user reflection object 211 in visual display 120.

According to this embodiment, a computer system receives the visual data from the visual data capture device 110, and interprets the gesture of the user's arm extension parsed from the visual data. In response to the visual data at moment 210, the computer system activates background image 221 and purse selections 222 to be displayed in visual display 120, as shown in moment 220. Next, the visual data capture device 110 captures a scene of the user's hand in a grabbing gesture, and displays virtual user reflection object 223 with background image 221 and purse selections 222. The computer system receives the visual data, and based on the grabbing gesture, selects purse image object 224 to couple with virtual user reflection object 223.

After the selection of purse image object 224 is made, purse image object 224 is persistently coupled to virtual user reflection object 223, as shown a moment 230, which allows for a user to move while maintaining the effect of virtual user reflection object 223 appearing to hold onto purse image object 224.

Although the embodiments described herein show a purse object as the virtual object that is selected and integrated into the virtual reflection, other virtual objects can be used in a like manner in other embodiments of the invention, including other apparel items and non-apparel items. In other embodiments, the apparel items that are selected may conform to the shape of the user's virtual body, such as a shirt, gloves, socks, shoes, trousers, skirt, or dress. In still other embodiments, the items include, but are not limited to other objects such as glasses, sunglasses, colored contacts, necklaces, scarves, stud, hoop, and dangling earrings and body rings, watches, finger rings, hair accessories, hairstyles. Non-apparel items include animals, snow, fantastical objects, sports equipment, and any object that can be made as an image or images by photography, animation, or other graphic-generating techniques.

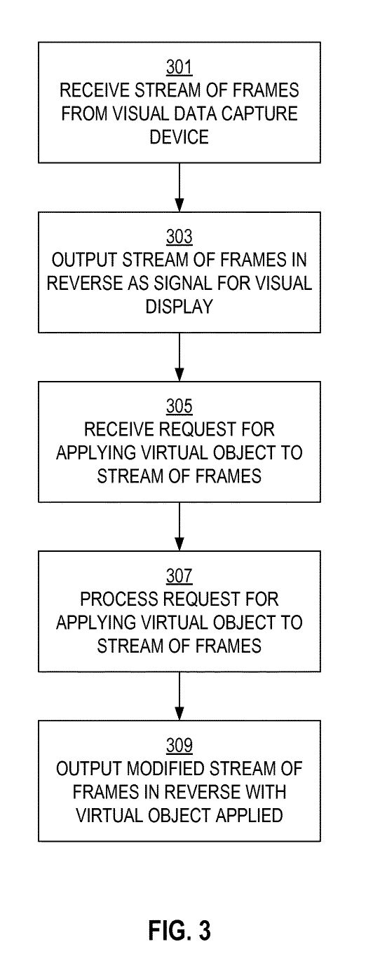

FIG. 3 is a flow diagram illustrating a computer-implemented process for video interaction with virtual objects according to at least one embodiment of the invention. At step 301, a stream of frames is received from a visual data capture device. At step 303, occurring concurrently with step 301, the stream of frames is output as a signal for a visual display, such as visual display 120. In an embodiment, the stream of frames are output in reverse. In the embodiment, there is minimal lag time between when a frame is received and when the frame in reverse is output. Thus, at step 303, a user captured by the video stream is presented with minor-image feedback of his or her image in an output video stream. In other embodiments, the output stream is not in reverse, but is in an original or other orientation. Through the use of minors or other optical devices, the mirror-image feedback can be achieved without reversing the output stream. In other embodiments, the output stream is the same orientation as the input stream, and the mirror-image feedback is not provided. In still other embodiments, the stream of frames is received and stored for later output as an output stream of frames. In such embodiments, the system receives a request for any user for applying to the stream of frames after the time of the capture of the video, including a user different from the user pictured in the video.

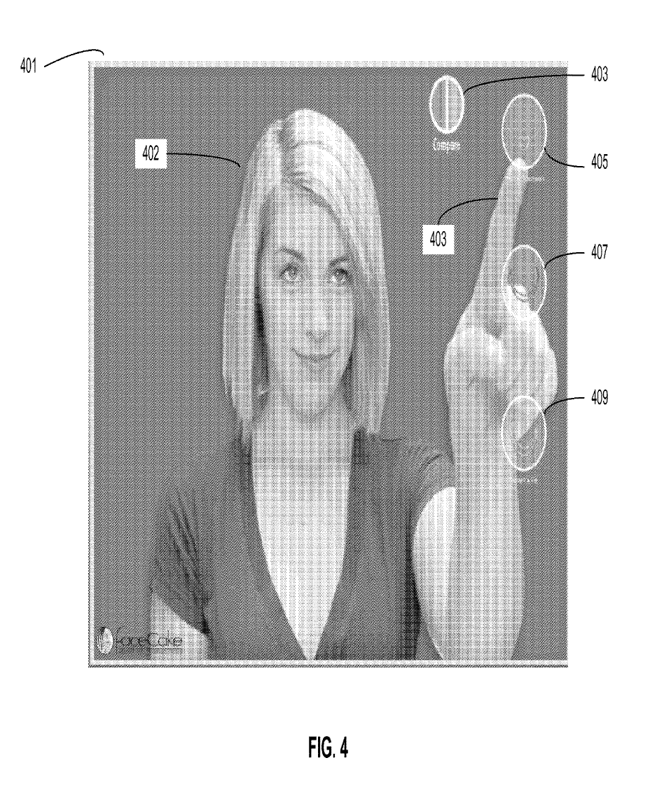

At step 305, a request for applying a virtual object to the stream of frames is received. In one embodiment, the request is triggered by a gesture or command by a user identified by the system, such as the arm extension and grabbing gestures described above with reference to FIG. 2. In one embodiment, as shown in FIG. 4 which illustrates one output frame 401 in an example embodiment of the invention, the output video stream is overlaid with icons 403-409, with which the user 402 interacts by making one or more virtual tapping gestures 411 that are captured by the visual data capture device as positioned at same frame location as the icon, and interpreted by the system as a selection of the icon. In the embodiment shown in FIG. 4, the system receives a request from the user 402 to apply a necklace to user's reverse image in the output stream of frames.

In other embodiments, the request is triggered by the system detecting a user's image in the stream of frames, not caused by any intentional user command. In one example embodiment, the system detects a user's image moving into frames of a stream of frames being captured and received. The presence of a user's image in one or more frames triggers the request at step 305. Other automatic request triggers include but are not limited to detecting a user moving through and stopping to look at the user's output image on a video display, detecting a user's image moving through the frame in a particular orientation, such as a predominantly forward-facing orientation facing the visual data capture device, or other features analyzed from the images in the stream of frames. In some embodiments, such image analyses are performed using computer vision techniques.

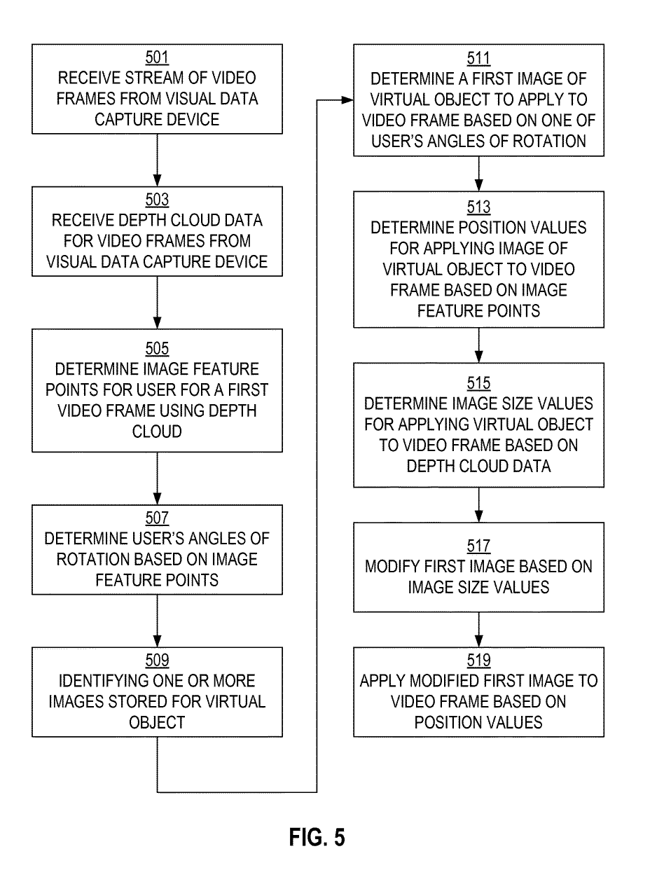

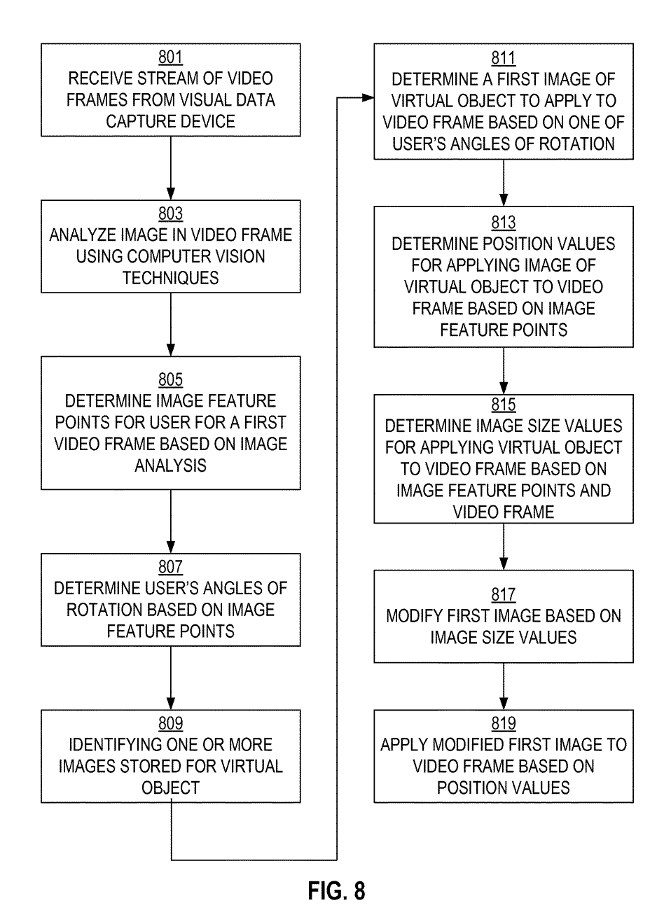

At step 307, the system processes the request for applying the virtual object to the stream of frames. Processing the request includes determining an appropriate position for applying the virtual object to the output image frame. Techniques for processing of the request according to some embodiments of the invention are presented in further detail below with reference to FIGS. 5 and 8.

At step 309, the system outputs the reverse stream of frames with the virtual object applied. In some embodiments, the virtual object is persistently coupled to a particular user's feature in the image, for example, the user's right arm, such that the virtual display appears to show the virtual object moving with the user's movements in real time. Thus, the output stream of frames, when viewed, looks as if it is a reflection of the virtual object being worn by the user in real-time. In other embodiments, the virtual object is persistently coupled until a gesture indicates a change in coupling to another of the user's features. For example, in some embodiments, while the virtual object is coupled to the right arm, a system detects a gesture by a left hand on the virtual object, and the virtual object is changed to couple with the left arm and hand. In such embodiments, the user can shift the virtual object from arm to arm, or body part to body part.

While the steps in the flow diagrams described herein are shown as a sequential series of steps, it is understood that some steps may be concurrent, the order of the steps may be different, there may be a substantial gap of time elapsed between steps, and certain steps may be skipped and steps not shown may be added to implement the process of video interaction with virtual objects as shown and described with respect to FIGS. 1, 2 and 4.

FIG. 5 is a flow diagram illustrating a process for applying a virtual object to an output stream of frames based on a concurrently captured stream of frames, wherein a visual data capture device captures video frames and depth cloud data, according to one embodiment of the invention. At step 501, the system receives a stream of video frames from a visual data capture device. At step 503, the system receives depth cloud data for video frames from the visual data capture device.

At step 505, image feature points such as image feature points or facial points for the user for a video frame of the stream of video frames is determined using the depth cloud data. At step 507, one or more angles of rotation for the user is determined based on the image feature points. In some embodiments, roll, pitch, and yaw is determined for each identified user feature. For example, the roll, pitch and yaw for a user's head, arm, torso, leg, hands, or feet is determined to determine a rotation angle for the user feature.

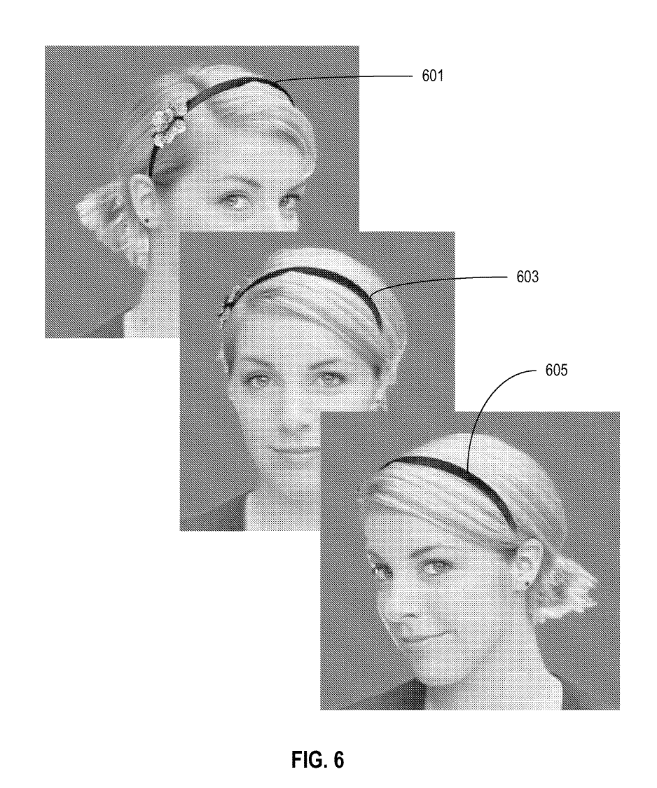

At step 509, one or more of images stored for a virtual object by the system are identified. At step 511, from among the stored images for the virtual object, the system determines an image to apply to the video frame based on one of the user's angles of rotation. In one embodiment, each of the plurality of images of the virtual object depicts the virtual object at a different yaw, roll and pitch. For example, as illustrated in FIG. 6, an image of a virtual headband at a first rotation 601 is used as the user's head is turned to the right in a first frame, an image at a second rotation 603 is used as the user's head is facing forward in a second frame, and an image at a third rotation 605 is used as the user's head is turned to the left in a third frame. According to some embodiments, only one image is stored for a virtual object. For such embodiments, the same image is identified to be applied regardless of the user's angle of rotation.

At step 513, position values are determined based on image feature points for applying the image of a particular rotation to the frame. At step 515, image size values are determined based on depth cloud data for applying the image of a particular rotation to the frame. For example, a larger image size value is determined for image feature points with a shorter depth than for image feature points for a longer depth.

At step 517, the image of a particular rotation is modified based on the image size values at a desired position. In some embodiments, certain virtual objects are associated with a particular user feature, and the position values of the user feature are determined for applying the virtual object. With reference to FIG. 6, the virtual headband is associated with a user's head at a particular relative position. In the embodiment shown in FIG. 6, in one example of executing step 517, the image of the headband at a particular rotation is modified based on the image size values for the user's head. In some embodiments, the image of a particular rotation is skewed or warped to correspond to different image size values for different positions, allowing for the virtual object to fit and conform over curves of the user.

At step 519, the modified image of a particular rotation is applied to the frame based on position values. In some embodiments, a desired position is based on gestures received from the user. For example, with reference the embodiment shown in FIG. 1, a system detects a gesture of putting a left hand on the virtual purse 130. The gesture will cause the virtual object on the next frame to be applied to position values determined for the hand instead of the left shoulder.

### Real-Time Comparison

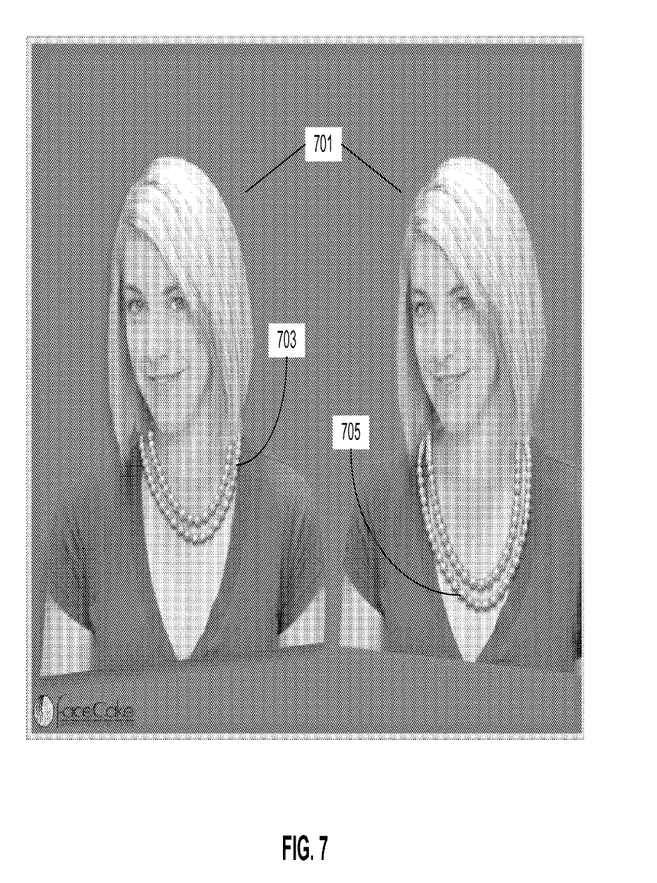

FIG. 7 illustrates the system performing a side-by-side comparison between one virtual object applied to one output stream, and another virtual object applied to another output stream, according to some embodiments of the invention. For example, the system receives a command to perform a side-by-side comparison. The system duplicates the output stream of frames into two or more streams. In some embodiments, the output streams are positioned such that user's virtual reflection appears on both sides of a split screen, reflecting the user's movement in real-time. FIG. 7 shows user 701 duplicated into two output streams. One side shows the user with necklace 703 in a short version. One side shows the user with necklace 705 in a long version.

FIG. 8 is a flow diagram illustrating a process for applying a virtual object to an output stream of frames based on a concurrently captured stream of frames without using depth cloud data, according to one embodiment of the invention. At step 801, a stream of video frames is received from a visual data capture device. At step 803, the system analyzes the image in the video frame using computer vision techniques. At step 805, based on the analysis, image feature points for the user are determined for a frame from a video stream.

At step 807, one or more of user's angles of rotation are determined. In some embodiments, roll, pitch, and yaw is determined for each identified user feature. For example, the roll, pitch and yaw for a user's head, arm, torso, leg, hands, or feet is determined to determine a rotation angle for the user feature.

At step 809, one or more stored images for a virtual object is identified. At step 811, from among the stored images for the virtual object, the system determines an image for the virtual object in particular rotation to apply to the video frame based on one of the user's angles of rotation. In one embodiment, each of the plurality of images of the virtual object depicts the virtual object at a different yaw, roll and pitch.

At step 813, position values are determined for applying the image for the virtual object of a particular rotation based on image feature points. At step 815, image size values for applying the virtual object to the video frame are determined based on image feature points and the video frame. At step 817, the image of the virtual object is modified based on the image size values. At step 819, the modified image of the virtual object is applied to the video frame based on position values. Additional techniques and variations for some embodiments as described with reference to FIG. 5 are available for use with the process of FIG. 8 where applicable.

### Gestures

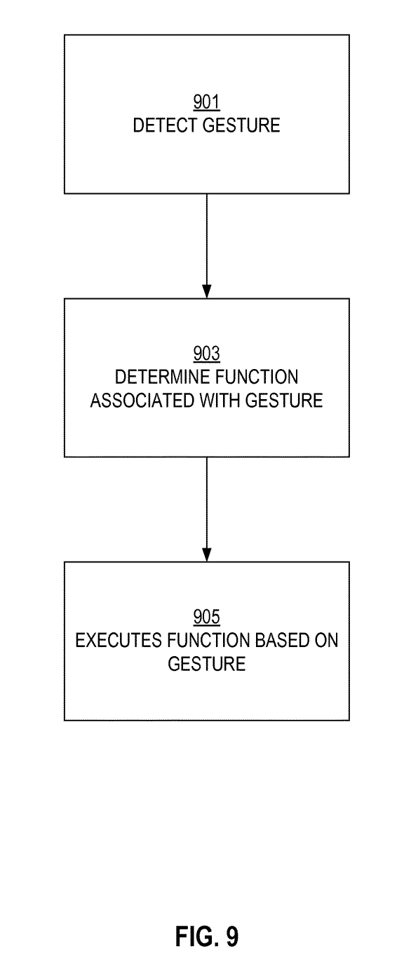

In some embodiments, gestures by the user that are detected by the system, and are interpreted by the system as commands corresponding to executing particular functions. A flowchart according to one embodiment of the invention is shown at FIG. 9 for executing a function based on a gesture. At step 901, the system detects a gesture by a user. At step 903, the system determines which function is associated with the gesture. At step 905, the system executes the function based on the gesture. In some embodiments of the invention, a gesture is detected by determining movement of a user feature based on transposing of interrelated image feature points from frame to frame. For example, a tapping gesture on an icon, as previously described with reference to FIG. 4, is associated with a selection command of the icon. The tapping gesture on the icon as determined to apply a necklace to the user's reverse image in the output stream of frames.

In another example, a hand-wave that is captured in the video stream as movement across most of the frame is associated with a clearing function for removing all overlaid virtual objects from the output stream. In some embodiments, the gesture of touching a virtual object causes the system to switch among the available variations of the virtual objects, or to switch back and forth between two variations of the virtual objects. Further, the size and shape of virtual objects can be modified and manipulated by gestures. For example, a grabbing gesture on a necklace is a command corresponding to the function of lengthening the necklace.

### Environment Simulation

In addition to applying virtual object onto the users image, in some embodiments of the invention, the system may mask out the background in each frame of the stream of frames around the user and replace it with another background to make it appear that the user is in a different environment and location. The background may be a static scene or a moving background stored in the system, or retrieved by the system for use from a repository of backgrounds. In some embodiments, the background is selected to complement the virtual object or objects being worn by the user. Furthermore, foreground elements may be virtually added to each frame to simulate weather or other objects around the user. Examples include snow or leaves falling around the user. Using the techniques described in FIGS. 1-8, the user may interact with these virtual elements. For example, virtual snow and virtual leaves are applied to the output stream of frames to show the objects collecting on the user's head and shoulders as they would in real life. Further details for this technique are set forth in co-pending application Ser. No. 12/714,518, which is incorporated by reference as if fully set forth herein. In other embodiments, for example, a fairy tale scene from “Snow White” is applied to an output stream of frames. Background objects or moving scenes include animals, which can be applied to a user feature to depict, for example, birds landing on the user's hand.

### Color Changes

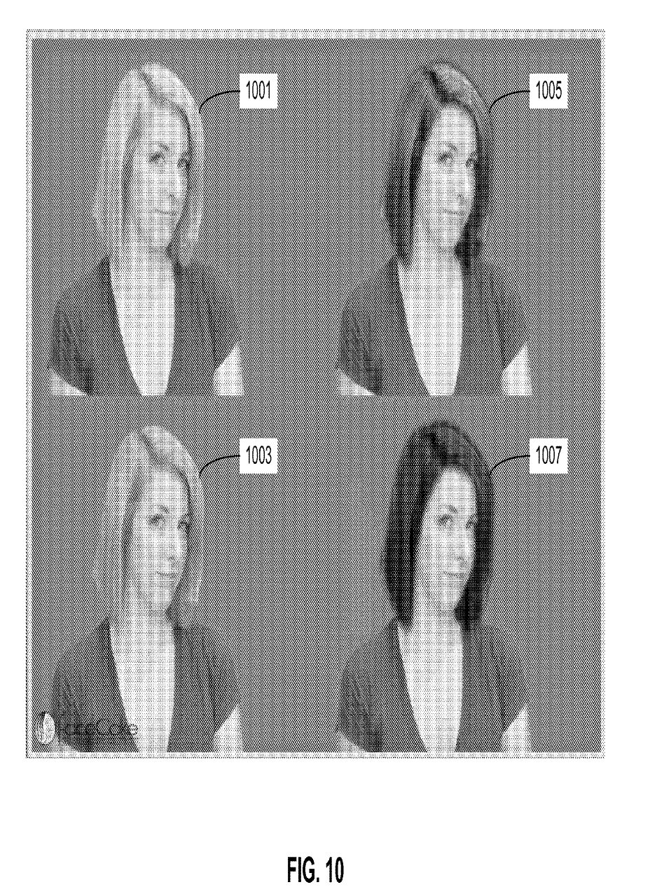

FIG. 10 illustrates the system changing user features in the stream of frames according to one embodiment of the invention, and showing a comparison between the variations while capturing and outputting the user's movements in real-time using techniques virtual objects applied as described above with reference to at least FIGS. 3, 5 and 8. According to one embodiment, the system detects user features based on image feature points and computer vision techniques. The system receives a command from user to change the color of a user feature. As illustrated in FIG. 10, the system applied four hair colors, and is showing a side-by-side comparison of each of the four applied hair colors. Other features whose color may be changed include facial features such as lip color and eye color.

### Shape Changes

According to one embodiment, the system detects user features based on image feature points and computer vision techniques. The system receives a request to change the shape of the user feature. In some embodiments, changes to one or more user features in the output stream of frames in real time include by are not limited to adding or subtracting size of body parts, changing facial features, and changing height. In one embodiment, once the changes are in place, the changes persist, and techniques for applying virtual objects, such as those described in FIGS. 3, 5 and 8, can be used with the changed user features.

### Clothing Physics

When the user applies virtual objects, the software may add animated motion to the applied image to enhance the realism of the product being applied. The software may apply moving transformation to simulate the movement of clothing and fabric and have it respond appropriately based on the users movements. This motion may also be used to highlight a promotional product being apply such a hairstyle moving “in the wind” to focus the user's attention on that product.

### Virtual Closet

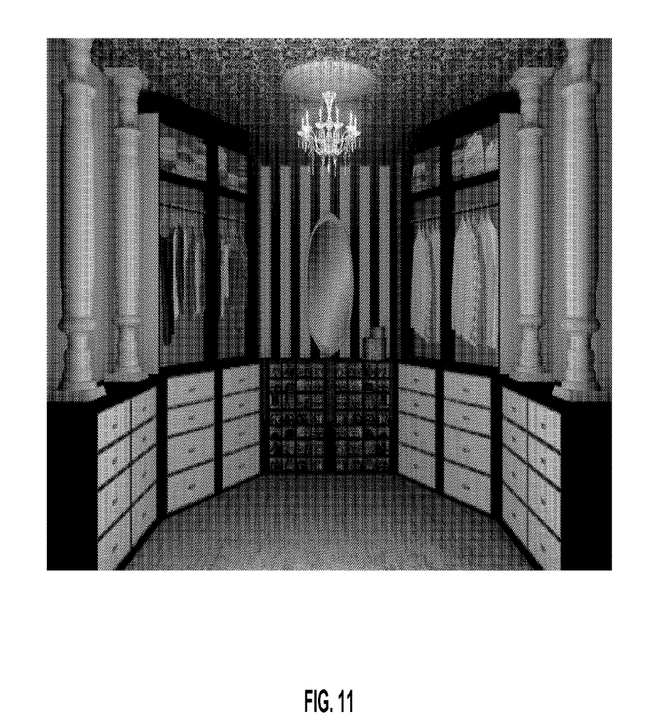

As shown in FIG. 11, according to some embodiments of the invention, a virtual closet (more specifically a personalized interactive virtual closet) lets the user collect and save the virtual objects available in the system to the virtual closet. Virtual objects are stored on centralized remote servers and are accessible by the user whenever she logs in with a user account when using the system. The virtual objects correspond to items that the user owns in the real world, owns virtually in digital form only, or does not own but wishes to own at a later date. Items may be added to the virtual closet by saving them while using the system, saving them from other interactions (e.g. adding from a retailer's web site) to use in the system later, or as a recommendation from a retailer, marketer, or manufacturer as a marketing opportunity. The virtual items saved in the virtual closet may be shared with and amongst the user's friends and family to review or try on themselves. The virtual closet can be decorated with virtual goods and designed by the user with the user favorites given premium position for try-on or viewing again.

### Social Sharing

According to one embodiment of the invention, multiple users may be able to view the visual display 120 at other visual displays connected over any computer network. For example, other virtual displays include one or more web browser displays at location that is remote from the on-camera user's location.

According to one embodiment, two such systems may be communicatively connected to allow two users who are simultaneously in two different virtual user reflection simulation sessions to interact with each other through the system.

According to one embodiment of the invention, the background display 221 can be chosen by the user, and modified by the user or automatically, at any time during a virtual user reflection simulation session.

According to one embodiment of the invention, the set of apparel objects that are offered to a user for selection are provided by third-party vendors on a real-time basis, based on the user's previous selections. In other embodiments, multiple auxiliary users who are viewing the virtual user reflection simulation session may cause other objects to be offered to the on-camera user.

### Hardware Overview

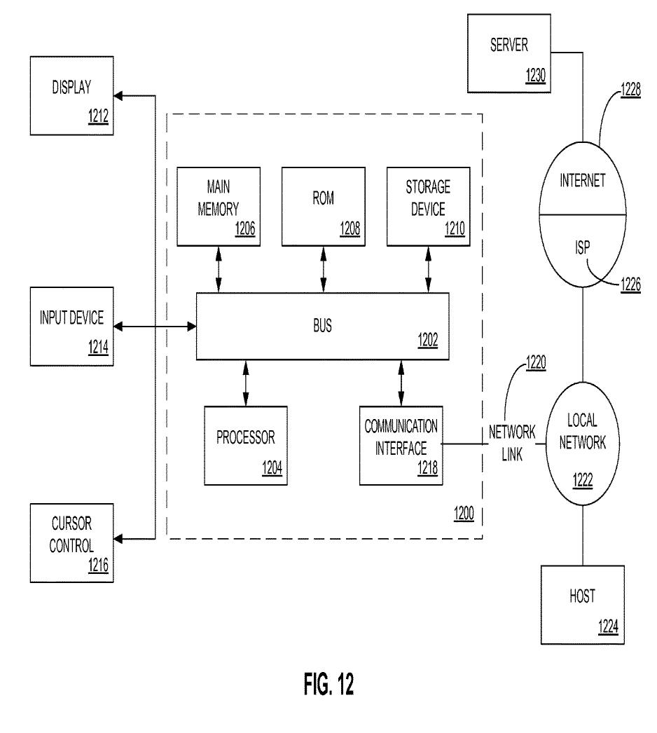

FIG. 12 is a block diagram that illustrates a computer system 1200 upon which an embodiment of the invention may be implemented. Computer system 1200 includes a bus 1202 or other communication mechanism for communicating information, and a processor 1204 coupled with bus 1202 for processing information. Computer system 1200 also includes a main memory 1206, such as a random access memory (RAM) or other dynamic storage device, coupled to bus 1202 for storing information and instructions to be executed by processor 1204. Main memory 1206 also may be used for storing temporary variables or other intermediate information during execution of instructions to be executed by processor 1204. Computer system 1200 further includes a read only memory (ROM) 1208 or other static storage device coupled to bus 1202 for storing static information and instructions for processor 1204. A storage device 1210, such as a magnetic disk or optical disk, is provided and coupled to bus 1202 for storing information and instructions.

Computer system 1200 may be coupled via bus 1202 to a display 1212, such as a cathode ray tube (CRT) or liquid crystal display (LCD), for displaying information to a computer user. An input device 1214, including alphanumeric and other keys, is coupled to bus 1202 for communicating information and command selections to processor 1204. Another type of user input device is cursor control 1216, such as a mouse, a trackball, or cursor direction keys for communicating direction information and command selections to processor 1204 and for controlling cursor movement on display 1212. This input device typically has two degrees of freedom in two axes, a first axis (e.g., x) and a second axis (e.g., y), that allows the device to specify positions in a plane. Another type of input device includes a video camera, a depth camera, or a 3D camera. Another type of input device includes a gesture-based input device, such as the Microsoft XBOX Kinect.

The invention is related to the use of computer system 1200 for implementing the techniques described herein. According to one embodiment of the invention, those techniques are performed by computer system 1200 in response to processor 1204 executing one or more sequences of one or more instructions contained in main memory 1206. Such instructions may be read into main memory 1206 from another machine-readable medium, such as storage device 1210. Execution of the sequences of instructions contained in main memory 1206 causes processor 1204 to perform the process steps described herein. In alternative embodiments, hard-wired circuitry may be used in place of or in combination with software instructions to implement the invention. Thus, embodiments of the invention are not limited to any specific combination of hardware circuitry and software. In further embodiments, multiple computer systems 1200 are operatively coupled to implement the embodiments in a distributed system.

The term “machine-readable medium” as used herein refers to any medium that participates in providing data that causes a machine to operation in a specific fashion. In an embodiment implemented using computer system 1200, various machine-readable media are involved, for example, in providing instructions to processor 1204 for execution. Such a medium may take many forms, including but not limited to storage media and transmission media. Storage media includes both non-volatile media and volatile media. Non-volatile media includes, for example, optical or magnetic disks, such as storage device 1210. Volatile media includes dynamic memory, such as main memory 1206. Transmission media includes coaxial cables, copper wire and fiber optics, including the wires that comprise bus 1202. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 1204 for execution. For example, the instructions may initially be carried on a magnetic disk of a remote computer. The remote computer can load the instructions into its dynamic memory and send the instructions over a telephone line using a modem. A modem local to computer system 1200 can receive the data on the telephone line and use an infra-red transmitter to convert the data to an infra-red signal. An infra-red detector can receive the data carried in the infra-red signal and appropriate circuitry can place the data on bus 1202. Bus 1202 carries the data to main memory 1206, from which processor 1204 retrieves and executes the instructions. The instructions received by main memory 1206 may optionally be stored on storage device 1210 either before or after execution by processor 1204.

Computer system 1200 also includes a communication interface 1218 coupled to bus 1202. Communication interface 1218 provides a two-way data communication coupling to a network link 1220 that is connected to a local network 1222. For example, communication interface 1218 may be an integrated services digital network (ISDN) card or other intern& connection device, or a modem to provide a data communication connection to a corresponding type of telephone line. As another example, communication interface 1218 may be a local area network (LAN) card to provide a data communication connection to a compatible LAN. Wireless network links may also be implemented. In any such implementation, communication interface 1218 sends and receives electrical, electromagnetic or optical signals that carry digital data streams representing various types of information.

Network link 1220 typically provides data communication through one or more networks to other data devices. For example, network link 1220 may provide a connection through local network 1222 to a host computer 1224 or to data equipment operated by an Internet Service Provider (ISP) 1226. ISP 1226 in turn provides data communication services through the world wide packet data communication network now commonly referred to as the Internet 1228. Local network 1222 and Internet 1228 both use electrical, electromagnetic or optical signals that carry digital data streams. The signals through the various networks and the signals on network link 1220 and through communication interface 1218, which carry the digital data to and from computer system 1200, are exemplary forms of carrier waves transporting the information.

Computer system 1200 can send messages and receive data, including program code, through the network(s), network link 1220 and communication interface 1218. In the Internet example, a server 1210 might transmit a requested code for an application program through Internet 1228, ISP 1226, local network 1222 and communication interface 1218.

The received code may be executed by processor 1204 as it is received, and/or stored in storage device 1210, or other non-volatile storage for later execution. In this manner, computer system 1200 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A computer-implemented method for video interaction with virtual objects, the method comprising the steps of:
receiving, by a computer, a stream of frames from a visual data capture device of a user in movement;
outputting a stream of frames as a video signal for processing by a visual display device based on the received stream of frames;
while receiving and outputting,
receiving a request for applying a virtual object to a stream of frames;
processing the request for applying the virtual object to one or more frames of the stream of frames; and
outputting a modified stream of frames with the virtual object applied to the one or more frames; and
for each frame in the stream of output frames:
determining image feature points for a user in a current output frame;
identifying one of a plurality of images stored in a storage medium for the virtual object;
determining a first image of the virtual object to apply to the current output frame;
determining a position for applying the virtual object to the current output frame; and
applying the first image of the virtual object to the current output frame.

2. A computer-implemented method of claim 1, further comprising determining one or more of user's angles of rotation in the first frame based on image feature points; and the determining of the first image is based on a particular angle of rotation.

3. A computer-implemented method of claim 1, wherein the determining a position further comprises determining position values for applying image of virtual object to the current output frame based on the image feature points.

4. A computer-implemented method of claim 1, wherein the virtual object applied to one or more frames is persistently coupled to a user feature.

5. A computer-implemented method of claim 5, wherein the user features includes a body part of the user.

6. A computer-implemented method of claim 5, wherein the user feature is determined from a stream of video using computer vision techniques.

7. A computer-implemented method of claim 1, wherein each of frames of the output stream of frames is the reverse image of a received frame.

8. A computer-implemented method of claim 8, wherein each of the reversed frames of the output stream of frames is outputted with minimal time elapsed between the receiving and the outputting.

9. A computer-implemented method of claim 1, wherein the output stream of frames comprises a virtual reflection of the user while in motion.

10. A system for video interaction with virtual objects, said system comprising:
one or more processors; and
a computer-readable storage medium carrying one or more sequences of instructions, which when executed by said one or more processors implement a method for video interaction with virtual objects, said method comprising:
receiving, by a computer, a stream of frames from a visual data capture device of a user in movement;
outputting a stream of frames as a video signal for processing by a visual display device based on the received stream of frames;
while receiving and outputting,
receiving a request for applying a virtual object to a stream of frames;
processing the request for applying the virtual object to one or more frames of the stream of frames; and
outputting a modified stream of frames with the virtual object applied to the one or more frames; and
for each frame in the stream of output frames:
determining image feature points for a user in a current output frame;
identifying one of a plurality of images stored in a storage medium for the virtual object;
determining a first image of the virtual object to apply to the current output frame;
determining a position for applying the virtual object to the current output frame; and
applying the first image of the virtual object to the current output frame. A system of claim 10, further comprising determining one or more of user's angles of rotation in the first frame based on the image feature points; and the determining of the first image is based on a particular angle of rotation. A system of claim 10, wherein the determining a position further comprises determining position values for applying image of virtual object to the current output frame based on the image feature points. A system of claim 10, wherein the virtual object applied to one or more frames is persistently coupled to a user feature.

14. A system of claim 13, wherein the user features includes a body part of the user.

15. A system of claim 13, wherein the user feature is determined from a stream of video using computer vision techniques.

16. A system of claim 10, wherein each of frames of the output stream of frames is the reverse image of a received frame.

17. A system of claim 16, wherein the each of the reversed frames of the output stream of frames is outputted with minimal time elapsed between the receiving and the outputting.

18. A system of claim 10, wherein the output stream of frames comprises a virtual reflection of the user while in motion.

19. A computer-implemented method of claim 1, wherein the step of determining a first image of the virtual object to apply to the current output frame comprises selecting said first image as a function of a user's gesture parsed from the stream of frames received from the visual data capture device.

20. A computer-implemented method of claim 19, wherein the user's gesture enables the selection of either the type of virtual object applied to the stream of frames or a characteristic of the virtual object.

21. A computer-implemented method of claim 1, wherein the processing further comprising the steps of:
receiving depth cloud data from said visual data capture device;
using said depth cloud data to determine image feature points for a user;
determining image size values for applying to said virtual object based on said depth cloud data; and
modifying said first image based on said image size values.

22. A computer-implemented method for video interaction with virtual objects, the method comprising the steps of:
receiving, by a computer, a stream of frames from a visual data capture device of a user in movement;
outputting a stream of frames as a video signal for processing by a visual display device based on the received stream of frames;
while receiving and outputting,
receiving a request for applying a virtual object to a stream of frames;
processing the request for applying the virtual object to one or more frames of the stream of frames; and
outputting a modified stream of frames with the virtual object applied to the one or more frames; and
for each frame in the stream of output frames:
determining image feature points for a user in a current output frame;
identifying one of a plurality of images stored in a storage medium for the virtual object; and
determining a first image of the virtual object to apply to the current output frame,
wherein said first image is selected as a function of a user's gesture parsed from the stream of frames received from the visual data capture device.

23. A computer-implemented method of claim 24, wherein the user's gesture enables the selection of either the type of virtual object applied to the stream of frames or a characteristic of the virtual object.

24. A computer-implemented method for video interaction with virtual objects, the method comprising the steps of:
receiving, by a computer, a stream of frames from a visual data capture device of a user in movement;
outputting a stream of frames as a video signal for processing by a visual display device based on the received stream of frames;
while receiving and outputting,
receiving a request for applying a virtual object to a stream of frames;
processing the request for applying the virtual object to one or more frames of the stream of frames; and
outputting a modified stream of frames with the virtual object applied to the one or more frames; and
for each frame in the stream of output frames:
determining image feature points for a user in a current output frame;
identifying one of a plurality of images stored in a storage medium for the virtual object;
determining a first image of the virtual object to apply to the current output frame;
determining a depth, size, and position for applying the virtual object to the current output frame; and applying the first image of the virtual object to the current output frame.
